(19) United States
(12) Patent Application Publication
(10) Pub. No.: US 2026/0276481 A1
(43) Pub. Date: Sep. 17, 2026

(54) DETERMINATION DEVICE

(71) Applicant: NSK LTD., Tokyo (JP)

(72) Inventors: Keiichiro TAGUCHI, Kanagawa (JP); Kosuke MAEDA, Kanagawa (JP)

(73) Assignee: NSK LTD., Tokyo (JP)

(21) Appl. No.: 19/479,908

(22) PCT Filed: Feb. 14, 2025
(86) PCT No.: PCT/JP2025/005002

§ 371 Date: Oct. 29, 2025

(30) Foreign Application Priority Data
Feb. 20, 2024 (JP) 2024-023325

(51) Int. Cl. G01M 13/04; G01N 27/02; G01N 27/04

(52) U.S. Cl. CPC G01M 13/04; G01N 27/025; G01N 27/045

(57) ABSTRACT

A probe includes a substantially columnar probe main body configured to detect an impedance of a bearing by coming into contact with a measurement target surface of the bearing, a housing having therein a sliding hole extending in an axial direction, the housing being configured to accommodate the probe main body disposed in the sliding hole, an abutting portion provided at a distal end portion of the housing and configured to abut against the measurement target surface of the bearing, and a biasing spring disposed in the sliding hole of the housing and configured to bias the probe main body in the axial direction with respect to the housing, the abutting portion includes four protrusions protruding in the axial direction, and when viewed from the axial direction, the four protrusions are respectively positioned at vertices of a rectangle centered on a central axis of the probe main body.

### TECHNICAL FIELD

The present invention relates to a determination device.

### BACKGROUND ART

For example, a rolling bearing for a papermaking machine, a wind power generation facility, a mine/construction facility, or a railway vehicle is used under severe lubrication conditions in which a heavy load is applied and foreign matter or water enters, and thus flaking of a bearing raceway surface becomes a problem. When flaking occurs in the rolling bearing, not only products and facilities may be greatly damaged, but also the production delivery date and schedule are affected. In order to prevent sudden flaking, the rolling bearing may be periodically disassembled and cleaned to inspect the appearance of the raceway surface. However, the prediction of the remaining life of the bearing (estimation of the period until the flaking occurs) by the appearance inspection depends on the experience and skill of the operator, and quantitative prediction is difficult.

With respect to this, Patent Literature 1 discloses a prediction method of inspecting a rolling bearing used by a user in a non-destructive manner and predicting a degree of fatigue progress or a remaining life of the rolling bearing. Specifically, the prediction method according to Patent Literature 1 includes a step of creating in advance a map, expressed on X-Y coordinate axes, of output voltage values obtained by measuring a rolling bearing with an eddy current, in which each coordinate on the map corresponds to a degree of fatigue progression or a remaining life; a step of measuring an output voltage value of a raceway surface or a rolling surface of the rolling bearing by an eddy current measurement device, and a step of obtaining a degree of fatigue progress or a remaining life of the rolling bearing by superimposing the measured output voltage value of the rolling bearing on the map. As a result, the bearing used by the user is inspected in a non-destructive manner, and the degree of fatigue progress or the remaining life of the rolling bearing can be predicted with high accuracy before damage due to fatigue progress occurs in the bearing.

### CITATION LIST

### Patent Literature

Patent Literature 1: JP2014-055941A

### SUMMARY OF INVENTION

### Technical Problem

The eddy current measurement device described in Patent Literature 1 applies an excitation current to a coil in a probe to induce an eddy current in a metal to be measured (an outer ring, an inner ring, and a rolling element of a rolling bearing), and detects an output voltage value generated in the coil by the eddy current to measure the amount of retained austenite in a non-destructive manner. Therefore, for example, when the output voltage value of the outer ring raceway surface is measured by the eddy current measurement device, it is necessary to bring the probe into contact with the outer ring raceway surface in a stably correct posture. Here, when a deviation occurs in the posture of the probe with respect to the outer ring during the measurement, the measurement value also changes, and it is not possible to accurately predict the degree of fatigue progress or the remaining life of the rolling bearing. In particular, when the measurement target surface is a curved surface, it is difficult to maintain the posture while appropriately bringing the probe into contact with the curved surface.

The present invention has been made in view of the above-described problems, and an object of the present invention is to provide a determination device capable of stabilizing a posture of a probe with respect to a bearing and accurately determining a degree of fatigue or a remaining life of the bearing.

### Solution to Problem

Therefore, the above object of the present invention is achieved by the following configuration [1].
[1] A determination device including:
a probe configured to induce an eddy current in a bearing by applying an alternating magnetic field and detect an impedance of the bearing;
a switch configured to transmit a measurement control signal for switching start and end of acquisition of a measurement signal of the impedance detected by the probe; and
a fatigue determination unit configured to determine a degree of fatigue or a remaining life of the bearing based on the impedance of the bearing, in which
the fatigue determination unit includes
a map storage unit configured to store a determination map including a relation between an impedance characteristic of the bearing and the degree of fatigue or the remaining life of the bearing,
a measurement switching unit configured to switch between a measurement execution state and a measurement non-execution state based on a state of the measurement control signal,
a data holding unit configured to hold the measurement signal in the measurement execution state,
an impedance characteristic calculation unit configured to calculate the impedance characteristic of the bearing based on the held measurement signal, and
a determination unit configured to determine the degree of fatigue or the remaining life of the bearing based on the impedance characteristic of the bearing and the determination map,
the probe includes
a substantially columnar probe main body configured to detect the impedance of the bearing by coming into contact with a measurement target surface of the bearing,
a housing having therein a sliding hole extending in an axial direction, the housing being configured to accommodate the probe main body disposed in the sliding hole in a manner of allowing the probe main body to slide in the axial direction,
an abutting portion provided at a distal end portion of the housing and configured to abut against the measurement target surface of the bearing, and
a biasing spring disposed in the sliding hole of the housing and configured to bias the probe main body in the axial direction with respect to the housing,
the abutting portion includes four protrusions protruding in the axial direction, and
when viewed from the axial direction, the four protrusions are respectively positioned at vertices of a rectangle centered on a central axis of the probe main body.

### Advantageous Effects of Invention

According to the determination device of the present invention, the posture of the probe with respect to the bearing can be stabilized, and the degree of fatigue or the remaining life of the bearing can be accurately determined.

### BRIEF DESCRIPTION OF DRAWINGS

FIG. 1 is a schematic configuration diagram of a determination device for determining a degree of fatigue or a remaining life of a bearing.

FIG. 2 is a schematic configuration diagram of a fatigue determination unit.

FIG. 3 is a schematic view illustrating a state in which an impedance of a raceway surface of an outer ring of a rolling bearing is measured by a probe.

FIG. 4 is a perspective view of the probe.

FIG. 5 is a cross-sectional view of the probe.

FIG. 6 is a cross-sectional view illustrating a state in which the probe is brought into perpendicular contact with the raceway surface of the outer ring.

FIG. 7 is a view seen in a direction of arrow VII in FIG. 6.

FIG. 8 is a cross-sectional view taken along line VIII1-VIII1 or a cross-sectional view taken along line VIII2-VIII2 in FIG. 6.

FIG. 9 is an enlarged view of the probe illustrated in FIG. 7.

FIG. 10 is a cross-sectional view illustrating a state in which the probe is brought into perpendicular contact with a raceway surface of an inner ring.

FIG. 11 is a view seen in a direction of arrow XI in FIG. 10.

FIG. 12 is a cross-sectional view taken along line XII-XII in FIG. 11.

FIG. 13 is a cross-sectional view taken along line XIII-XIII in FIG. 11.

FIG. 14 is an enlarged view of the probe illustrated in FIG. 11.

FIG. 15 is an enlarged view of a part in FIG. 11.

### DESCRIPTION OF EMBODIMENTS

Hereinafter, a determination device for determining a degree of fatigue or a remaining life of a bearing according to each embodiment of the present invention will be described in detail with reference to the drawings.

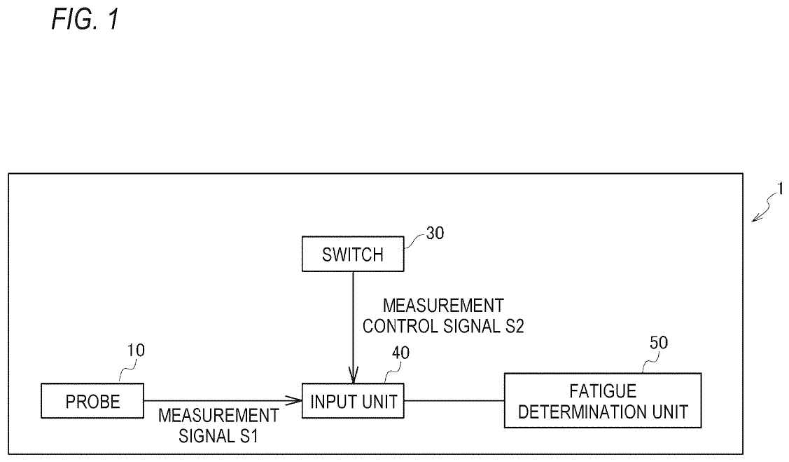

FIG. 1 is a schematic configuration diagram of the determination device for determining a degree of fatigue or a remaining life of a bearing. As illustrated in FIG. 1, a determination device 1 includes a probe 10 configured to induce an eddy current in a bearing by applying an alternating magnetic field and detect an impedance of the bearing, a switch 30 configured to transmit a measurement control signal S2 for switching start and end of acquisition of a measurement signal S1 of the impedance detected by the probe 10, an input unit 40 configured to acquire the measurement signal S1 and the measurement control signal S2, and a fatigue determination unit 50 configured to determine a degree of fatigue or a remaining life of the bearing based on the impedance of the bearing.

A coil (not illustrated) is incorporated in the probe 10. An eddy current is induced by applying an excitation current to the coil in the probe 10 and applying the alternating magnetic field to the bearing (for example, an outer ring, an inner ring, or a rolling element of a rolling bearing) to be measured, and an impedance generated in the coil by the eddy current is detected, whereby a metal structure (for example, the amount of retained austenite) is measured in a non-destructive manner. Examples of a measurement target surface of the bearing include a raceway surface, an outer peripheral surface, and both end surfaces in the axial direction of the outer ring, a raceway surface, an inner peripheral surface, and both end surfaces in the axial direction of the inner ring, and a peripheral surface of the rolling element.

When the probe 10 is in contact with the measurement target surface of the bearing, the measurement signal S1 of the impedance of the bearing is always transmitted to the fatigue determination unit 50 via the input unit 40. However, as will be described later, the fatigue determination unit 50 does not always acquire the measurement signal S1, and the acquisition of the measurement signal S1 is switched between execution and non-execution based on the state of the measurement control signal S2 transmitted by the switch 30.

The switch 30 is a member that can be pressed by a user. For example, in a state in which the switch 30 is pressed (ON state), the measurement control signal S2 for switching the start and end of the acquisition of the measurement signal S1 is transmitted to the input unit 40, and in a state in which the switch 30 is not pressed (OFF state), the measurement control signal S2 is not transmitted to the input unit 40. For example, when the measurement control signal S2 is transmitted to the input unit 40, the measurement signal S1 is received by the fatigue determination unit 50, resulting in the measurement execution state in which the measurement is executed, and when the measurement control signal S2 is not transmitted to the input unit 40, the measurement signal S1 is not received by the fatigue determination unit 50, resulting in the measurement non-execution state in which the measurement is not executed.

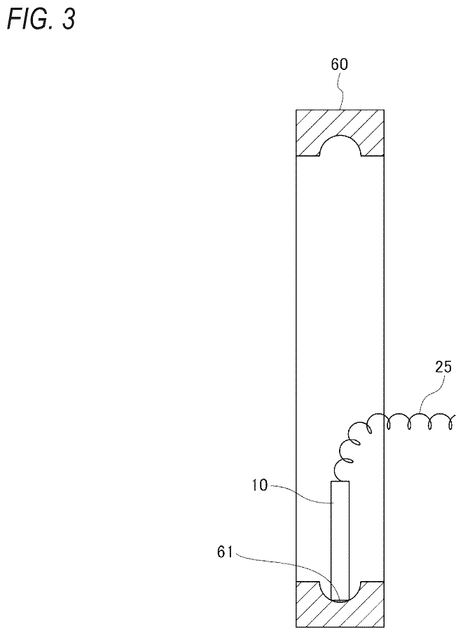

The input unit 40 includes an A/D converter (not illustrated) that is connected to the probe 10 via a cable 25 (see FIG. 3) described later and receives the measurement signal S1 of the impedance of the bearing detected by the probe 10, and a digital input/output unit (not illustrated) that is connected to the switch 30 and receives the measurement control signal S2 transmitted by the switch 30. The measurement signal S1 and the measurement control signal S2 are transmitted to the fatigue determination unit 50 via the input unit 40.

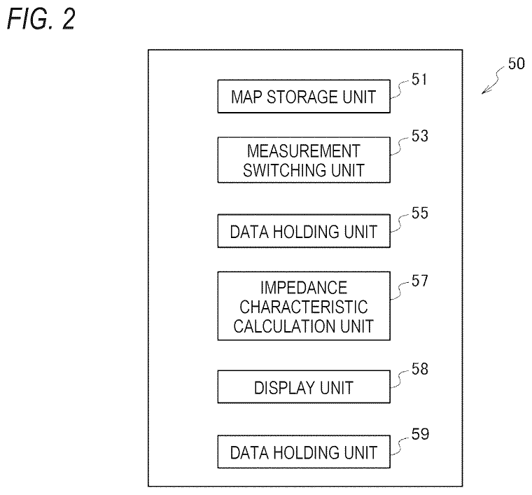

FIG. 2 is a schematic configuration diagram of the fatigue determination unit. As illustrated in FIG. 2, the fatigue determination unit 50 includes a map storage unit 51 configured to store a determination map including a relation between an impedance characteristic (resistance component and reactance component) of the bearing and the degree of fatigue or the remaining life of the bearing, a measurement switching unit 53 configured to switch between a measurement execution state and a measurement non-execution state based on a state of the measurement control signal S2, a data holding unit 55 configured to hold the measurement signal S1 in the measurement execution state, an impedance characteristic calculation unit 57 configured to calculate the impedance characteristic (resistance component and reactance component) of the bearing based on the held measurement signal S1, a determination unit 59 configured to determine the degree of fatigue or the remaining life of the bearing based on the impedance characteristic (resistance component and reactance component) of the bearing and the determination map, and a display unit 58 configured to display a determination result.

The fatigue determination unit 50 may include, for example, a computer including a processor and peripheral components such as a storage device. The processor may be, for example, a central processing unit (CPU) or a micro-processing unit (MPU). The storage device may include any of a semiconductor storage device, a magnetic storage device, and an optical storage device. The storage device may include a register, a cache memory, and a memory such as a read only memory (ROM) and a random access memory (RAM) used as a main storage device. The fatigue determination unit 50 may be implemented by dedicated hardware for executing each information processing. For example, the fatigue determination unit 50 may include a functional logic circuit set in a general-purpose semiconductor integrated circuit. For example, the fatigue determination unit 50 may include a programmable logic device (PLD) such as a field-programmable gate array (FPGA).

The fatigue determination unit 50 obtains the remaining life of the bearing with reference to a correlation relation between the characteristic of the impedance measured by the probe 10 and the determination map stored in the map storage unit 51, and displays the remaining life on the display unit 58 such as a display.

FIG. 3 is a schematic view illustrating a state in which an impedance of a raceway surface 61 of an outer ring 60 of a rolling bearing is measured by the probe 10. As illustrated in FIG. 3, the probe 10 comes into contact with the raceway surface 61, induces an eddy current in the raceway surface 61 by applying an alternating magnetic field, and detects the impedance of the raceway surface 61. The measurement signal S1 of the detected impedance is transmitted to the input unit 40 via the cable 25. When the measurement target surface is the raceway surface 61 of the outer ring 60 as described above, the map storage unit 51 of the fatigue determination unit 50 stores in advance the determination map including a relation between the resistance component and the reactance component, which are the impedance characteristics of the raceway surface 61 of the outer ring 60, and the degree of fatigue or the remaining life of the outer ring 60. Therefore, when the impedance characteristic of the raceway surface 61 of the outer ring 60 is measured, the degree of fatigue or the remaining life of the outer ring 60 is determined based on the determination map.

Based on the state of the measurement control signal S2, the measurement switching unit 53 switches between the measurement execution state in which the measurement signal S1 is received by the fatigue determination unit 50 and measurement is executed and the measurement non-execution state in which the measurement signal S1 is not received by the fatigue determination unit 50 and measurement is not executed. For example, the measurement switching unit 53 sets the measurement execution state when the measurement control signal S2 is transmitted from the switch 30 to the input unit 40, and sets the measurement non-execution state when the measurement control signal S2 is not transmitted from the switch 30 to the input unit 40. Therefore, after confirming that the probe 10 is in contact with the raceway surface 61 of the outer ring 60 in a correct posture, the user presses the switch 30 to cause the determination device 1 to transition to the measurement execution state.

The data holding unit 55 holds the measurement signal S1 of the impedance of the raceway surface 61 of the outer ring 60 in the measurement execution state.

The impedance characteristic calculation unit 57 calculates the resistance component and the reactance component of the impedance of the raceway surface 61 of the outer ring 60 based on the measurement signal S1 held in the data holding unit 55.

The determination unit 59 determines the degree of fatigue or the remaining life of the outer ring 60 based on the resistance component and the reactance component of the impedance of the raceway surface 61 of the outer ring 60 calculated by the impedance characteristic calculation unit 57 and the determination map stored in the map storage unit 51. The determined degree of fatigue or remaining life of the outer ring 60 is displayed on the display unit 58.

Although the degree of fatigue or the remaining life of the bearing is determined by the determination device 1 having the above-described configuration, in order to accurately measure the impedance of the bearing, it is necessary to stably bring the probe 10 into contact with the measurement target surface in a correct posture. The correct posture of the probe 10 is, for example, a posture in which the probe 10 is perpendicular to the measurement target surface. The configuration of the probe 10 adopted to stably bring the probe 10 into contact with the bearing in a correct posture during measurement will be described in detail.

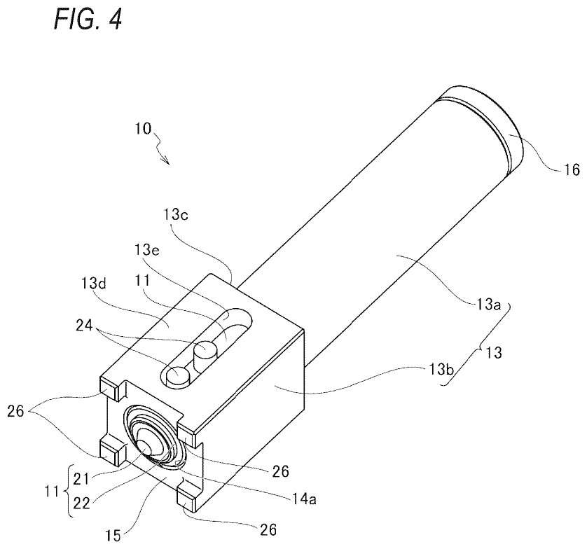

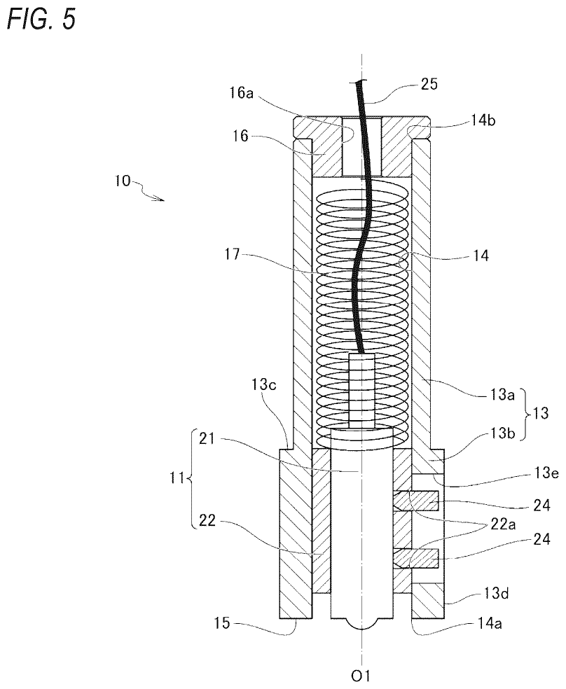

FIG. 4 is a perspective view of the probe. FIG. 5 is a cross-sectional view of the probe. As illustrated in FIGS. 4 and 5, the probe 10 includes a substantially columnar probe main body 11 configured to detect the impedance of the bearing by coming into contact with the measurement target surface of the bearing, a housing 13 having therein a sliding hole 14 extending in an axial direction, the housing 13 being configured to accommodate the probe main body 11 disposed in the sliding hole 14 in a manner of allowing the probe main body 11 to slide in the axial direction, an abutting portion 15 provided at a distal end portion of the housing 13 and configured to abut against the measurement target surface of the bearing, and a coil spring 17 serving as a biasing spring disposed in the sliding hole 14 of the housing 13 and configured to bias the probe main body 11 in the axial direction with respect to the housing 13.

The housing 13 is an elongated tubular member extending in the axial direction (a longitudinal direction of the housing 13, a vertical direction in FIG. 5), and is formed by connecting and integrating a substantially cylindrical base portion 13a and a substantially rectangular parallelepiped distal end portion 13b provided coaxially with each other in the axial direction. The housing 13 is made of resin in order to prevent influence on impedance measurement. The sliding hole 14 extends so as to penetrate through the base portion 13a and the distal end portion 13b of the housing 13 in the axial direction. Since the sliding hole 14 has the same diameter over the entire range in the axial direction, the inner diameter of the base portion 13a and the inner diameter of the distal end portion 13b are the same. Meanwhile, the outer diameter of the distal end portion 13b is larger than the outer diameter of the base portion 13a, and therefore, a step portion 13c perpendicular to the axial direction is formed at the connection portion between the distal end portion 13b and the base portion 13a. For example, the user grips the base portion 13a of the housing 13 and brings the probe 10 into contact with the measurement target surface. The user may hold the distal end portion 13b of the housing 13.

The sliding hole 14 includes a distal end portion opening 14a formed in the distal end portion (lower portion in FIG. 5) of the housing 13 and a base portion opening 14b formed in the base portion (upper portion in FIG. 5) of the housing 13. As will be described later, the probe main body 11 is biased toward the distal end side of the probe 10 by the coil spring 17, and the probe main body 11 can protrude outward from the distal end portion opening 14a of the sliding hole 14 by this biasing force. A lid portion 16 having a through hole 16a at A center thereof is fitted into the base portion opening 14b of the sliding hole 14. The cable 25 connected to the probe main body 11 is drawn out from the through hole 16a of the lid portion 16.

One of four outer peripheral surfaces 13d of the distal end portion 13b of the housing 13 is formed with a long hole 13e penetrating the outer peripheral surface 13d in a radial direction. The long hole 13e is a long hole whose dimension in the axial direction is longer than dimensions in two directions perpendicular to the axial direction. A pair of pins 24, 24 fixed to a holder portion 22 of the probe main body 11 to be described later are disposed in the long hole 13e. When the probe main body 11 slides in the axial direction, the pair of pins 24, 24 slide in the long hole 13e. Then, the pair of pins 24, 24 come into contact with both end portions (both upper and lower end portions in FIG. 5) in the axial direction of the long hole 13e to restrict sliding, so that a moving distance of the probe main body 11 in the axial direction is limited.

The probe main body 11 includes, as separate members, a probe portion 21, and the holder portion 22 configured to house the probe portion 21 therein and is allowed to slide with respect to the sliding hole 14 of the housing 13. As described above, by forming the probe portion 21 and the holder portion 22 as separate members, when one of the probe portion 21 and the holder portion 22 is damaged, parts can be replaced independently, and the maintenance cost is reduced. The probe portion 21 and the holder portion 22 are made of resin in order to prevent influence on impedance measurement.

The probe portion 21 has a substantially columnar shape, and a coil (not illustrated) is embedded therein. The cable 25 for extracting the measurement signal S1 is connected to a base end side (upper side in FIG. 5) of the probe portion 21. The cable 25 extends in the sliding hole 14 and is drawn to the outside from the through hole 16a of the lid portion 16 installed in the base portion opening 14b. The drawn cable 25 is connected to the input unit 40 (see FIG. 1).

The holder portion 22 has a substantially cylindrical shape covering the probe portion 21 from the outer periphery. A pair of female screw holes 22a, 22a separated from each other in the axial direction are formed in a part of the holder portion 22, and the pin 24 is screwed into each of the pair of female screw holes 22a, 22a. The pair of pins 24, 24 fixes the probe portion 21 and the holder portion 22. Therefore, when the holder portion 22 slides with respect to the sliding hole 14, the probe portion 21 also slides integrally. The pair of pins 24, 24 protrude further to the outer diameter side than the pair of female screw holes 22a, 22a, and the pair of pins 24, 24 come into contact with both end portions in the axial direction of the long hole 13e to restrict sliding, so that the moving distance in the axial direction of the probe main body 11 is limited.

The probe main body 11 including the probe portion 21 and the holder portion 22 is disposed on a distal end side of the sliding hole 14. Meanwhile, the coil spring 17 is disposed on a base end side of the sliding hole 14. The coil spring 17 extends in the axial direction so as to come into contact with the lid portion 16 fixed to the housing 13 and the probe main body 11. As a result, the probe main body 11 is biased toward the distal end side with respect to the housing 13 by the coil spring 17.

The coil spring 17 of the present embodiment abuts on the holder portion 22 positioned on an outer peripheral side of the probe main body 11. Therefore, since the outer diameter of the coil spring 17 can be set to be substantially equal to the inner diameter of the sliding hole 14 and the coil spring 17 can be guided by the sliding hole 14, buckling of the coil spring 17 is prevented and the biasing force is stabilized.

In addition, a gap exists on an inner diameter side of the coil spring 17, and the cable 25 of the probe main body 11 extends so as to penetrate this gap. Since the cable 25 is disposed in a dead space on the inner diameter side of the coil spring 17 in this manner, it contributes to miniaturization of the probe 10.

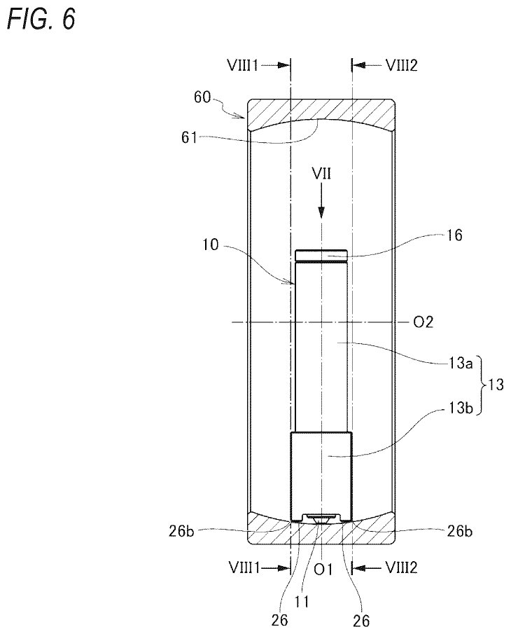

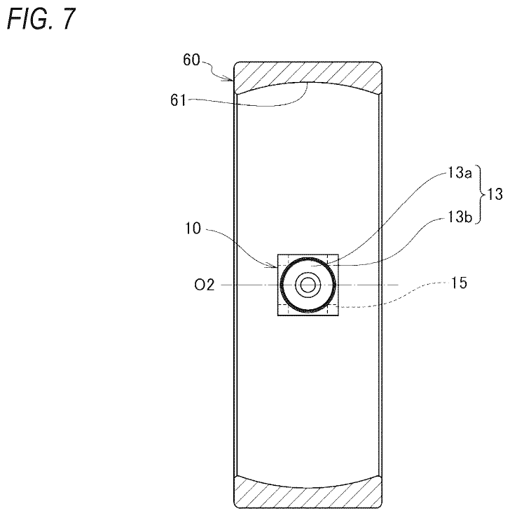

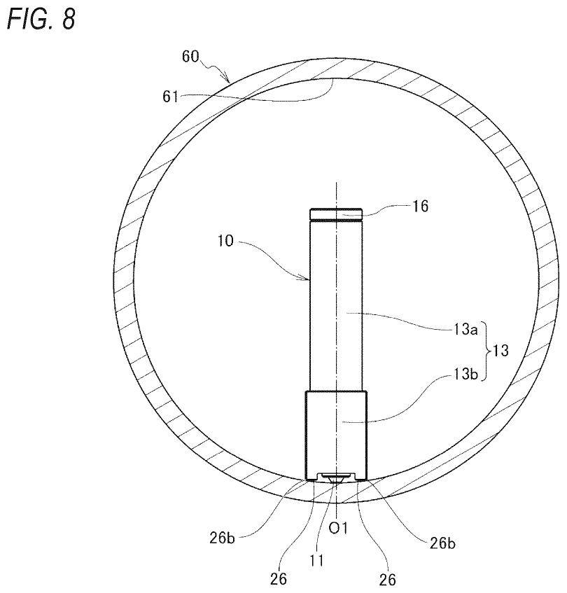

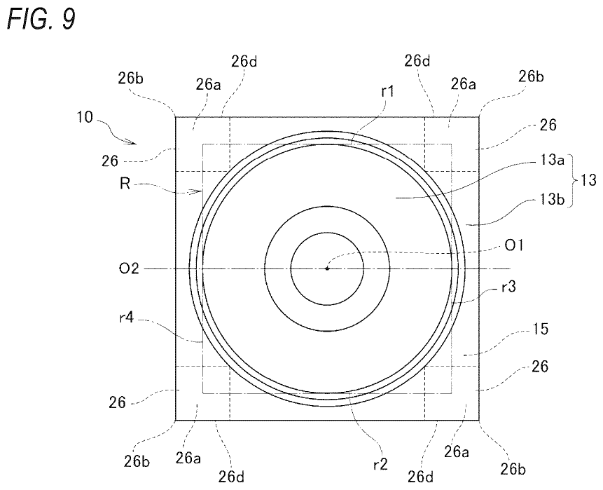

FIG. 6 is a cross-sectional view illustrating a state in which the probe is brought into perpendicular contact with the raceway surface of the outer ring. FIG. 7 is a view seen in a direction of arrow VII in FIG. 6. FIG. 8 is a cross-sectional view taken along line VIII1-VIII1 or a cross-sectional view taken along line VIII2-VIII2 in FIG. 6. FIG. 9 is an enlarged view of the probe illustrated in FIG. 7.

As illustrated in FIGS. 4 to 9, the distal end portion 13b having a substantially rectangular parallelepiped shape of the housing 13 is provided with the abutting portion 15 configured to abut against the raceway surface 61 of the outer ring 60 which is a measurement target surface. The raceway surface 61 of the outer ring 60 used in the description of the embodiment is a concave spherical surface. The shape of the raceway surface 61 is optional, and may be, for example, a cylindrical shape. In particular, as illustrated in FIGS. 7 and 9, the shape of the abutting portion 15 when viewed from the axial direction is preferably rectangular, and is square in the illustrated example.

The abutting portion 15 includes four protrusions 26 having the same shape and protruding in the axial direction. As illustrated in FIG. 9, the protrusion 26 has a substantially rectangular parallelepiped shape, and a distal end surface 26a of the protrusion 26 has a rectangular shape. The four protrusions 26 are disposed at the vertices of the rectangle of the abutting portion 15. Further, when viewed from the axial direction, the four protrusions 26 are respectively positioned at the vertices of a rectangle R centered on a central axis O1 of the probe main body 11. In FIG. 9, the rectangle R is a square indicated by a dashed line, and connects the centers of the distal end surfaces 26a of the four protrusions 26. Therefore, the four protrusions 26 are disposed at positions equidistant from the central axis O1 and are disposed at equal intervals in the circumferential direction with respect to the central axis O1. The rectangle R is not necessarily a square and may be, for example, a rectangle. The rectangle R is preferably similar in shape to the rectangle of the abutting portion 15.

As illustrated in FIGS. 6 to 9, during measurement, it is necessary to maintain a correct posture in which the probe 10 is perpendicular to the raceway surface 61 of the outer ring 60. Therefore, the user brings all of the four protrusions 26 of the abutting portion 15 into contact with the raceway surface 61 of the outer ring 60.

The four protrusions 26 come into contact with the raceway surface 61, which is a concave spherical surface, at outer corner portions 26b farthest from the central axis Ol of the probe main body 11. As described above, by bringing the outer corner portions 26b of the four protrusions 26 into contact with the raceway surface 61, the probe main body 11 can be maintained perpendicular to the raceway surface 61, and a stable measurement result can be obtained.

When all the outer corner portions 26b of the four protrusions 26 come into contact with the raceway surface 61, the user can perceive that the wobble of the gripped probe 10 is eliminated and the posture of the probe 10 is stabilized. Then, the user presses the switch 30 to start acquiring the measurement signal S1, and the degree of fatigue or the remaining life of the bearing is determined.

When the raceway surface 61 has a cylindrical shape concentric with a central axis O2 of the outer ring 60, it is necessary to maintain a correct posture in which the probe 10 is perpendicular to the raceway surface 61 during measurement. In this case, as illustrated in FIG. 9, adjustment may be performed such that the central axis O1 of the probe main body 11 and the central axis O2 of the outer ring 60 are perpendicular to each other, two sides r1 and r2 parallel to each other among four sides constituting the rectangle R are parallel to the central axis O2 of the outer ring 60, and the other two sides r3 and r4 parallel to each other among the four sides constituting the rectangle R are perpendicular to the central axis O2 of the outer ring 60. The pair of protrusions 26, 26 on one side in the circumferential direction (upper side in FIG. 9) are separated from each other in the direction of the central axis O2 of the outer ring 60, and similarly, the pair of protrusions 26, 26 on the other side in the circumferential direction (lower side in FIG. 9) are separated from each other in the direction of the central axis O2 of the outer ring 60. The positions where the four protrusions 26 contact the raceway surface 61 are different from those in the case in which the raceway surface 61 is a concave spherical surface. When the raceway surface 61 has a cylindrical shape, the four protrusions 26 come into contact with the raceway surface 61 at circumferential outer sides 26d including the outer corner portions 26b.

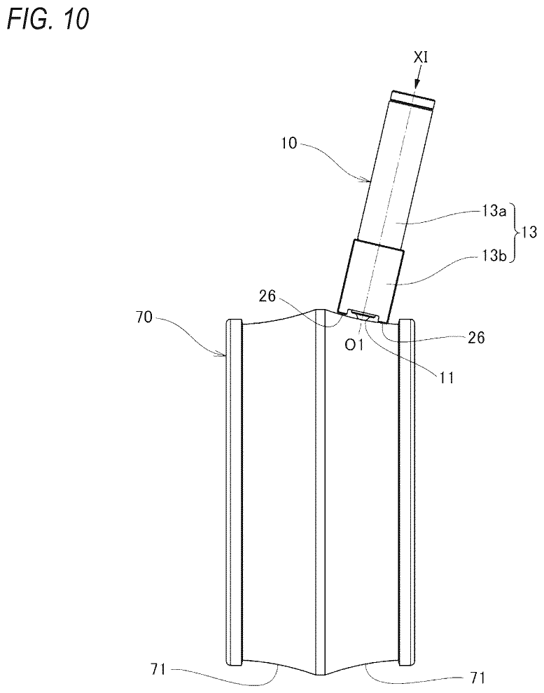

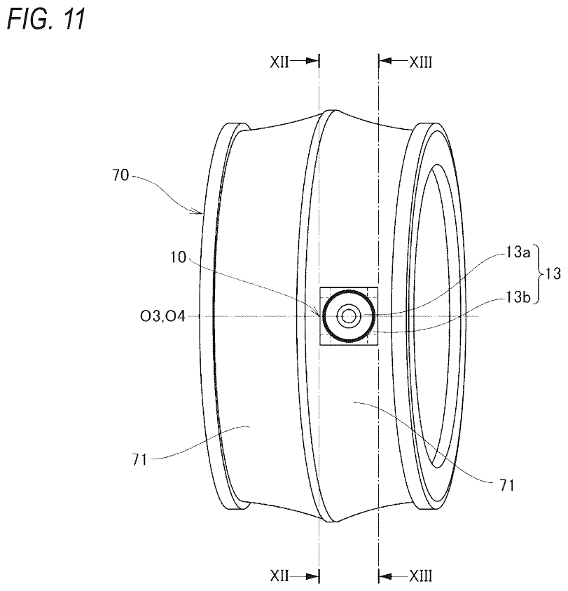

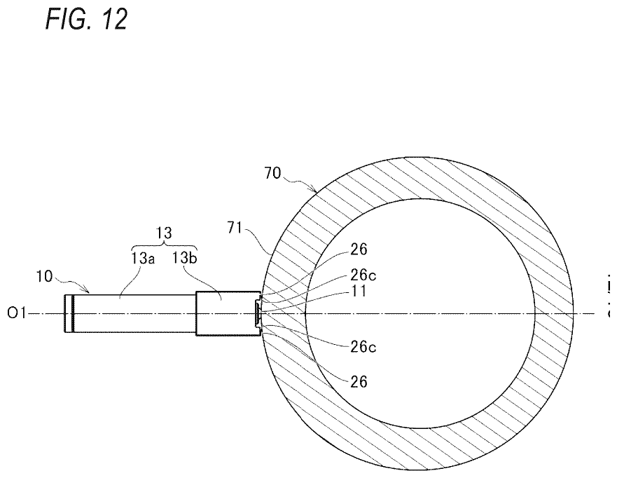

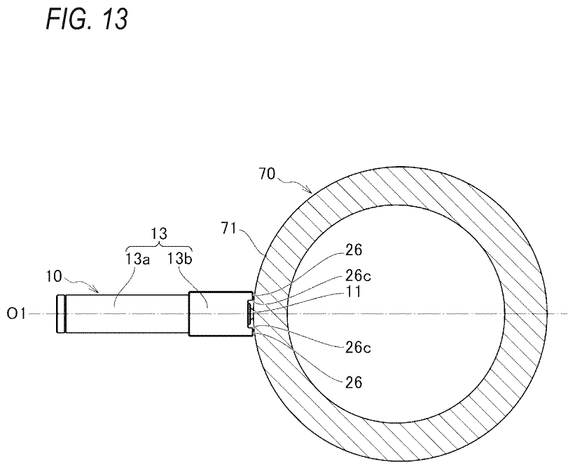

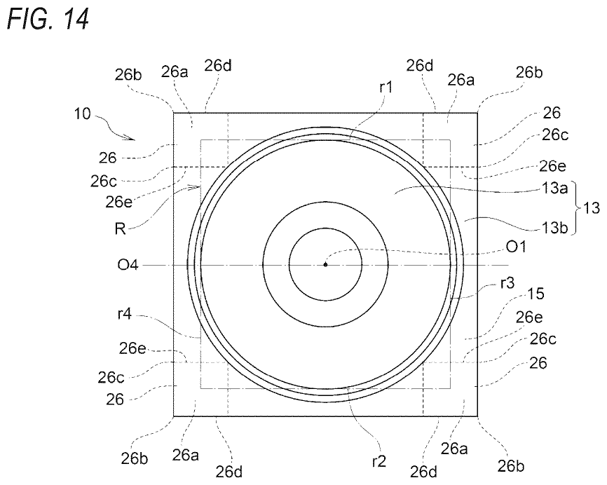

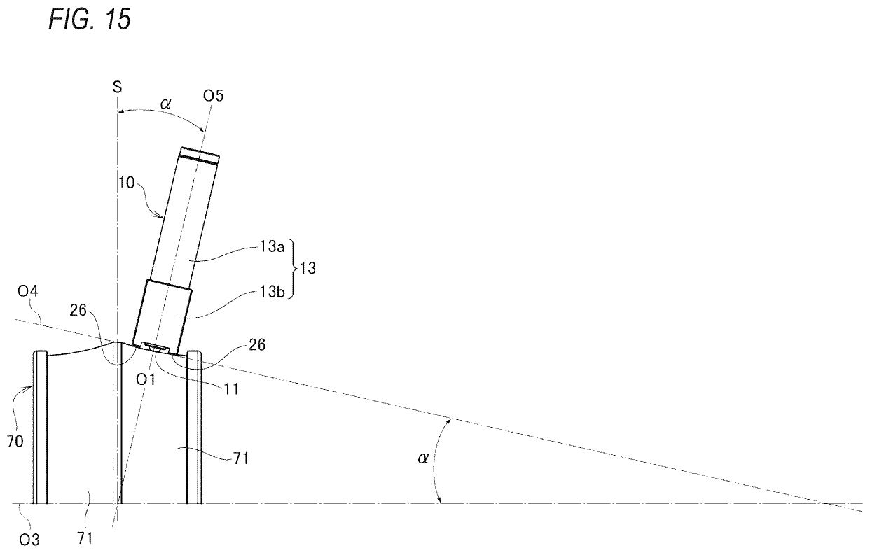

Next, a case of measuring a raceway surface 71 formed on an outer peripheral surface of an inner ring 70 will be described. FIG. 10 is a cross-sectional view illustrating a state in which the probe is brought into perpendicular contact with the raceway surface of the inner ring. FIG. 11 is a view seen in a direction of arrow XI in FIG. 10. FIG. 12 is a cross-sectional view taken along line XII-XII in FIG. 11. FIG. 13 is a cross-sectional view taken along line XIII-XIII in FIG. 11. FIG. 14 is an enlarged view of the probe illustrated in FIG. 11. FIG. 15 is an enlarged view of a part in FIG. 10.

Double row raceway surfaces 71, 71 are formed on the outer peripheral surface of the inner ring 70 in the illustrated example. The raceway surface 71 is a convex curved surface. The shape of the raceway surface 71 is optional, and may be, for example, a cylindrical shape. As illustrated in FIGS. 10 to 15, during measurement, it is necessary to maintain a correct posture in which the probe 10 is perpendicular to the raceway surface 71 of the inner ring 70. Therefore, the user adjusts the orientation of the probe 10 so that all the four protrusions 26 of the abutting portion 15 come into contact with the raceway surface 71 of the inner ring 70. Specifically, as illustrated in FIGS. 14 and 15, adjustment may be performed such that the central axis Ol of the probe main body 11 and a normal direction O4 of a contact angle o of the inner ring 70 are perpendicular to each other, two sides r1 and r2 parallel to each other among the four sides constituting the rectangle R are parallel to the normal direction O4 of the contact angle α, and the other two sides r3 and r4 parallel to each other among the four sides constituting the rectangle R are perpendicular to the normal direction O4 of the contact angle α.

Here, the normal direction O4 of the contact angle α will be described with reference to FIG. 15. In FIG. 15, a is the contact angle, O3 is a central axis of the inner ring 70, O4 is the normal direction of the contact angle α, and O5 is a contact angle direction. The contact angle a is defined by a “nominal contact angle” described in Japanese Industrial Standards JIS B 0104-1991 “Rolling bearings—Vocabulary”, and is an angle formed by a surface S orthogonal to the central axis O3 of the inner ring 70 and the contact angle direction O5. The contact angle direction O5 is the direction of the line of action of the load, and is the direction of the force applied from a rolling element (not illustrated) to the inner ring 70. The normal direction O4 of the contact angle α is a direction passing through the raceway surface 71 and orthogonal to the contact angle direction O5. When the probe 10 is in a correct posture perpendicular to the raceway surface 71, the central axis Ol of the probe main body 11 coincides with the contact angle direction O5 and is perpendicular to the normal direction O4 of the contact angle α.

In this way, when the four protrusions 26 are brought into contact with the raceway surface 71, as illustrated in FIG. 14, a pair of protrusions 26 are positioned on both sides in the circumferential direction so as to sandwich the normal direction O4 of the contact angle α. The pair of protrusions 26, 26 on one side in the circumferential direction (upper side in FIG. 14) are separated from each other in the normal direction O4 of the contact angle α, and similarly, the pair of protrusions 26, 26 on the other side in the circumferential direction (lower side in FIG. 14) are separated from each other in the normal direction O4 of the contact angle α of the inner ring 70.

The four protrusions 26 come into contact with the raceway surface 71, which is a convex curved surface, at inner comer portions 26c. The inner corner portion 26c is a corner portion positioned on the outer side in the normal direction O4 of the contact angle α and positioned on the inner side in the circumferential direction among the four corner portions of the distal end surface 26a of the protrusion 26. As described above, by bringing the inner comer portions 26c of the four protrusions 26 into contact with the raceway surface 71, the probe main body 11 can be maintained perpendicular to the raceway surface 71, and a stable measurement result can be obtained.

When all the inner corner portions 26c of the four protrusions 26 come into contact with the raceway surface 71, the user can perceive that the wobble of the gripped probe 10 is eliminated and the posture of the probe 10 is stabilized. Then, the user presses the switch 30 to start acquiring the measurement signal S1, and the degree of fatigue or the remaining life of the bearing is determined.

Even when the raceway surface 71 has a cylindrical shape concentric with the central axis O3 of the inner ring 70, it is necessary to maintain a correct posture in which the probe 10 is perpendicular to the raceway surface 71 during measurement. In this case, although not particularly illustrated, adjustment may be performed such that the central axis O1 of the probe main body 11 and the central axis O3 of the inner ring 70 are perpendicular to each other, two sides r1 and r2 parallel to each other among the four sides constituting the rectangle R are parallel to the central axis O3 of the inner ring 70, and the other two sides r3 and r4 parallel to each other among the four sides constituting the rectangle R are perpendicular to the central axis O3 of the inner ring 70. The pair of protrusions 26, 26 on one side in the circumferential direction (upper side in FIG. 14) are separated from each other in the direction of the central axis O3 of the inner ring 70, and similarly, the pair of protrusions 26, 26 on the other side in the circumferential direction (lower side in FIG. 14) are separated from each other in the direction of the central axis O3 of the inner ring 70. The positions where the four protrusions 26 come into contact with the raceway surface 71 are different from those when the raceway surface 71 is a convex spherical surface. When the raceway surface 71 has a cylindrical shape, the four protrusions 26 come into contact with the raceway surface 61 at a circumferential inner side 26e (see FIG. 14) including the inner corner portion 26c.

In the illustrated example, the abutting portion 15 has a rectangular shape when viewed from the axial direction, and the four protrusions 26 are disposed at vertices of the rectangle of the abutting portion 15. Therefore, the four protrusions 26 can be provided on the abutting portion 15 with high space efficiency, and the distance between the adjacent protrusions 26 can be increased to stabilize the posture of the probe 10.

The shape of the abutting portion 15 when viewed from the axial direction is not limited to a rectangular shape, and may be any shape, for example, a circular shape for easy manufacturing.

Further, in the illustrated example, the shape of the distal end surface 26a of the protrusion 26 viewed from the axial direction is rectangular. Accordingly, with respect to the raceway surface 61 of the outer ring 60 whose measurement target surface is a concave spherical surface, the posture of the probe 10 can be stably maintained by bringing the outer corner portions 26b of the four protrusions 26 into contact with the raceway surface 61. In the case of the raceway surface 71 of the inner ring 70 whose measurement target surface is a convex curved surface, the posture of the probe 10 can be stably maintained by bringing the inner corner portions 26c of the four protrusions 26 into contact with the measurement target surface. Furthermore, although not particularly illustrated, when the measurement target surface is a flat surface, the posture of the probe 10 can be stably maintained by bringing the entire distal end surfaces 26a of the four protrusions 26 into contact with the measurement target surface.

The shape of the distal end surface 26a of the protrusion 26 when viewed from the axial direction is not limited to a rectangular shape, and may be any shape, for example, a circular shape for easy manufacturing.

In the illustrated example, the protrusion 26 is provided integrally with the abutting portion 15, but the protrusion 26 may be a pin separate from the abutting portion 15. In this case, a fixing method of the pin constituting the protrusion 26 is optional, and examples include a fixing method of adhering the pin to the abutting portion 15, or a fixing method of pressing or screwing the pin into a hole formed in the abutting portion 15. As described above, by forming the protrusion 26 as a separate member, the protrusion 26 can be replaced when being damaged or worn. Further, the protrusion 26 can be replaced with an appropriate protrusion 26 for a different measurement target surface according to characteristics such as shape and roughness.

The present invention is not limited to the above embodiments and can be appropriately modified, improved, and the like.

As described above, the following matters are disclosed in the present specification.
(1) A determination device including:
a probe configured to induce an eddy current in a bearing by applying an alternating magnetic field and detect an impedance of the bearing;
a switch configured to transmit a measurement control signal for switching start and end of acquisition of a measurement signal of the impedance detected by the probe; and
a fatigue determination unit configured to determine a degree of fatigue or a remaining life of the bearing based on the impedance of the bearing, in which
the fatigue determination unit includes
a map storage unit configured to store a determination map including a relation between an impedance characteristic of the bearing and the degree of fatigue or the remaining life of the bearing,
a measurement switching unit configured to switch between a measurement execution state and a measurement non-execution state based on a state of the measurement control signal,
a data holding unit configured to hold the measurement signal in the measurement execution state,
an impedance characteristic calculation unit configured to calculate the impedance characteristic of the bearing based on the held measurement signal, and
a determination unit configured to determine the degree of fatigue or the remaining life of the bearing based on the impedance characteristic of the bearing and the determination map,
the probe includes
a substantially columnar probe main body configured to detect the impedance of the bearing by coming into contact with a measurement target surface of the bearing,
a housing having therein a sliding hole extending in an axial direction, the housing being configured to accommodate the probe main body disposed in the sliding hole in a manner of allowing the probe main body to slide in the axial direction,
an abutting portion provided at a distal end portion of the housing and configured to abut against the measurement target surface of the bearing, and
a biasing spring disposed in the sliding hole of the housing and configured to bias the probe main body in the axial direction with respect to the housing,
the abutting portion includes four protrusions protruding in the axial direction, and
when viewed from the axial direction, the four protrusions are respectively positioned at vertices of a rectangle centered on a central axis of the probe main body.
(2) The determination device according to (1), in which
the abutting portion has a rectangular shape when viewed from the axial direction, and the four protrusions are disposed at vertices of the rectangle of the abutting portion.
(3) The determination device according to (1), in which
the abutting portion has a circular shape when viewed from the axial direction.
(4) The determination device according to any one of (1) to (3), in which
a distal end surface of the protrusion has a rectangular shape when viewed from the axial direction.
(5) The determination device according to any one of (1) to (3), in which
a distal end surface of the protrusion has a circular shape when viewed from the axial direction.
(6) The determination device according to any one of (1) to (5), in which
the protrusion is a pin separate from the abutting portion and is fixed to the abutting portion.
(7) The determination device according to any one of (1) to (6), in which
the probe main body includes, as separate members,
a probe portion having a coil, and
a holder portion configured to house the probe portion therein and is allowed to slide with respect to the sliding hole of the housing.
(8) The determination device according to (7), in which
the biasing spring is a coil spring, and
the coil spring is configured to bias the holder portion of the probe main body.
(9) The determination device according to (8), in which
the probe main body includes a cable configured to extract the measurement signal, and
the cable penetrates an inner diameter side of the coil spring.

The present application is based on a Japanese patent application (No. 2024-023325) filed on Feb. 20, 2024 contents of which are incorporated herein by reference.

### REFERENCE SIGNS LIST

1: determination device
10: probe
11: probe main body
13: housing
13a: base portion
13b: distal end portion
13c: step portion
13d: outer peripheral surface
13e: long hole
14: sliding hole
14a: distal end portion opening
14b: base portion opening
15: abutting portion
17: coil spring (biasing spring)
21: probe portion
22: holder portion
22a: female screw hole
24: pin
25: cable
26: protrusion
26a: distal end surface
26b: outer corner portion
26c: inner corner portion
26d: circumferential outer side
26e: circumferential inner side
30: switch
40: input unit
50: fatigue determination unit
51: map storage unit
53: measurement switching unit
55: data holding unit
57: impedance characteristic calculation unit
58: display unit
59: determination unit
60: outer ring (bearing)
61: raceway surface (measurement target surface)
70: inner ring (bearing)
71: raceway surface (measurement target surface)
O1: central axis of probe main body
O2: central axis of outer ring
O3: central axis of inner ring
O4: normal direction of contact angle
O5: contact angle direction

1. A determination device comprising:
a probe configured to induce an eddy current in a bearing by applying an alternating magnetic field and detect an impedance of the bearing;
a switch configured to transmit a measurement control signal for switching start and end of acquisition of a measurement signal of the impedance detected by the probe; and
a fatigue determination unit configured to determine a degree of fatigue or a remaining life of the bearing based on the impedance of the bearing, wherein
the fatigue determination unit includes
a map storage unit configured to store a determination map including a relation between an impedance characteristic of the bearing and the degree of fatigue or the remaining life of the bearing,
a measurement switching unit configured to switch between a measurement execution state and a measurement non-execution state based on a state of the measurement control signal,
a data holding unit configured to hold the measurement signal in the measurement execution state,
an impedance characteristic calculation unit configured to calculate the impedance characteristic of the bearing based on the held measurement signal, and
a determination unit configured to determine the degree of fatigue or the remaining life of the bearing based on the impedance characteristic of the bearing and the determination map,
the probe includes
a substantially columnar probe main body configured to detect the impedance of the bearing by coming into contact with a measurement target surface of the bearing,
a housing having therein a sliding hole extending in an axial direction, the housing being configured to accommodate the probe main body disposed in the sliding hole in a manner of allowing the probe main body to slide in the axial direction,
an abutting portion provided at a distal end portion of the housing and configured to abut against the measurement target surface of the bearing, and
a biasing spring disposed in the sliding hole of the housing and configured to bias the probe main body in the axial direction with respect to the housing,
the abutting portion includes four protrusions protruding in the axial direction, and
when viewed from the axial direction, the four protrusions are respectively positioned at vertices of a rectangle centered on a central axis of the probe main body.

2. The determination device according to claim 1, wherein
the abutting portion has a rectangular shape when viewed from the axial direction, and the four protrusions are disposed at vertices of the rectangle of the abutting portion.

3. The determination device according to claim 1, wherein
the abutting portion has a circular shape when viewed from the axial direction.

4. The determination device according to claim 1, wherein
a distal end surface of the protrusion has a rectangular shape when viewed from the axial direction.

5. The determination device according to claim 1, wherein
a distal end surface of the protrusion has a circular shape when viewed from the axial direction.

6. The determination device according to claim 1, wherein
the protrusion is a pin separate from the abutting portion and is fixed to the abutting portion.

7. The determination device according to claim 1, wherein
the probe main body includes, as separate members,
a probe portion having a coil, and
a holder portion configured to house the probe portion therein and is allowed to slide with respect to the sliding hole of the housing.

8. The determination device according to claim 7, wherein
the biasing spring is a coil spring, and
the coil spring is configured to bias the holder portion of the probe main body.

9. The determination device according to claim 8, wherein
the probe main body includes a cable configured to extract the measurement signal, and
the cable penetrates an inner diameter side of the coil spring.
